(19) United States
(12) Patent Application Publication
(10) Pub. No.: US 2024/0104233 A1
(43) Pub. Date: Mar. 28, 2024

(54) CONTENT TAGGING AND LIMITED SHARING

(71) Applicant: INTERNATIONAL BUSINESS MACHINES CORPORATION, ARMONK, NY (US)

(72) Inventors: Varadarajan Ramamoorthy, Cary, NC (US); Danny Soroker, Larchmont, NY (US); Marshall Allen Lamb, Raleigh, NC (US)

(21) Appl. No.: 17/935,673

(22) Filed: Sep. 27, 2022

(51) Int. Cl. G06F 21/62; G06F 16/9035; G06F 16/9038; G06F 16/93; G06F 21/60; G06Q 20/36

(52) U.S. Cl. CPC G06F 21/6218; G06F 16/9035; G06F 16/9038; G06F 16/93; G06F 21/602; G06Q 20/367

(57) ABSTRACT

According to one embodiment, a method, computer system, and computer program product for tagging and sharing limited views of content. The embodiment may include identifying one or more roles corresponding to one or more users. The embodiment may also include determining a set of tags corresponding to sections of a document. The embodiment may further include associating tags from the set of tags with associated roles from the one or more roles. The embodiment may also include filtering a view of the document for a user from the one or more users according to the tags from the set of tags, the associated roles, and a set of roles corresponding to the user. The embodiment may further include presenting the view of the document to the user.

### BACKGROUND

The present invention relates generally to the field of computing, and more particularly to file access.

File access is a series of procedures whereby file systems, databases, and web servers govern access to various files and information among users. Access often includes permission to read, write, or modify a file. File access control mechanisms may be paired with security mechanisms to ensure that authorized users, and only authorized users, have access to the relevant documents, or relevant parts of a document. An effective access control scheme can make complex shared filesystems, including web-based and cloud-based filesystems, very practical for business organizations, friend groups, families, and other collaborative enterprises.

### SUMMARY

According to one embodiment, a method, computer system, and computer program product for tagging and sharing limited views of content. The embodiment may include identifying one or more roles corresponding to one or more users. The embodiment may also include determining a set of tags corresponding to sections of a document. The embodiment may further include associating tags from the set of tags with associated roles from the one or more roles. The embodiment may also include filtering a view of the document for a user from the one or more users according to the tags from the set of tags, the associated roles, and a set of roles corresponding to the user. The embodiment may further include presenting the view of the document to the user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computing environment according to at least one embodiment.

FIG. 2 illustrates an operational flowchart for a process for easily tagging content and sharing it in a limited manner.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to file access. The following described exemplary embodiments provide a system, method, and program product to, among other things, easily tag content and share it in a limited manner. Therefore, the present embodiment has the capacity to improve the technical field of file access by providing a process to grant access to a limited view of documents based on roles and tags.

As previously described, file access is a series of procedures whereby file systems, databases, and web servers govern access to various files and information among users. Access often includes permission to read, write, or modify a file. File access control mechanisms may be paired with security mechanisms to ensure that authorized users, and only authorized users, have access to the relevant documents, or relevant parts of a document. An effective access control scheme can make complex shared filesystems, including web-based and cloud-based filesystems, very practical for business organizations, friend groups, families, and other collaborative enterprises.

An effective access control scheme grants the relevant access to the correct users, and no more or less. Granting and maintaining such access to users on an individual basis can be time-consuming and hard to track, leading to compounding technical and human error. Individualized access lists may further lack context for why a given user has access to a given document at all. Furthermore, systems based on tagging individual documents provide limited options for subdivision of permissions into relevant purposes. As such, it may be advantageous to dynamically grant users access to limited views of a document based on coherent, meaningful roles and tags.

According to at least one embodiment, roles may be determined for several users. Content in a document may then be tagged with tags corresponding to the roles. The document may then be filtered according to tags and roles, and the filtered view of the document may be provided to users with the appropriate roles.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as content tagging and limited sharing program 150. In addition to content tagging and limited sharing program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and content tagging and limited sharing program 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

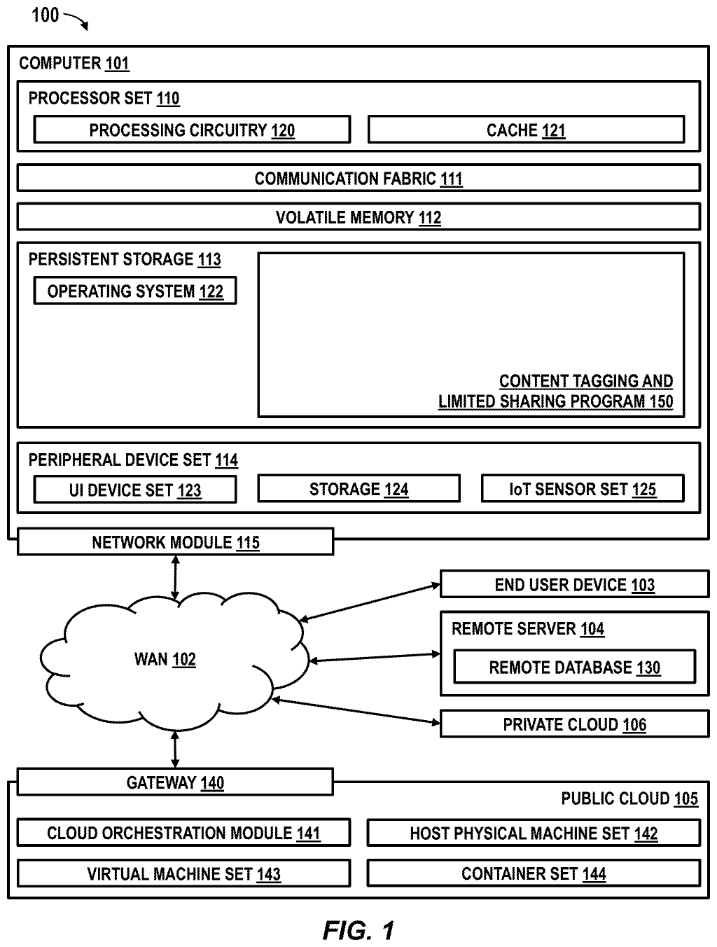

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in content tagging and limited sharing program 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in content tagging and limited sharing program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of the Bluetooth Special Interest Group and/or its affiliates) connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi® network. The WAN 102 and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

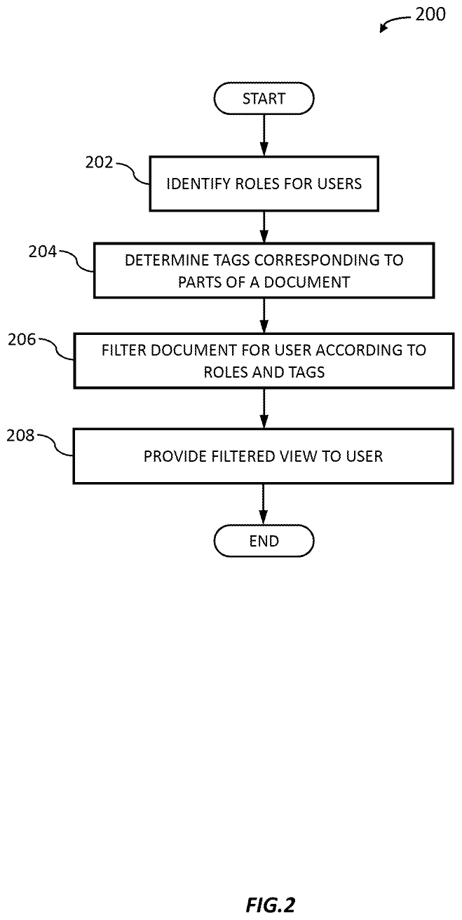

Content tagging and limited sharing program 150 may identify roles corresponding to users. The content tagging and limited sharing program 150 may then determine tags corresponding to sections of a document and mapping to roles. For example, if a document relates to an event, parts of the document relating to food may be tagged with a food tag, which may correspond to a catering role, which in turn represents caterers. The content tagging and limited sharing program 150 may filter a document based on tags and roles and provide users with access to the filtered view of the document. Notwithstanding depiction in computer 101, content tagging and limited sharing program 150 may be stored in and/or executed by, individually or in any combination, end user device 103, remote server 104, public cloud 105, and private cloud 106. The method for content tagging and limited sharing is explained in further detail below with respect to FIG. 2.

Referring now to FIG. 2, an operational flowchart illustrating a process for easily tagging content and sharing it in a limited manner 200 is depicted according to at least one embodiment. At 202, the content tagging and limited sharing program 150 identifies roles corresponding to users. A role may be, for example, a job role, a vendor role, a family role, or similar. Roles may be identified from an external source, assigned manually, assigned by an algorithmic process, or assigned by a combination of these methods.

In at least one embodiment, roles may be assigned manually. For example, roles may be assigned by an administrative user. Alternatively, roles may be assigned by any user with a given role, such as a landscaper granting other users a landscaper role. Alternatively, users may select their own roles.

In another embodiment, roles may be assigned by an algorithmic process, including use of an Application Programming Interface (“API”), a process of artificial intelligence, or use of a random number generator. For example, a game may assign roles such as “banker,” “dealer,” or “investigator” to a random user.

In an alternate embodiment, roles may be taken from an existing source. For example, roles may be assigned separately by a company's human resources (“HR”) management software and used in content tagging and limited sharing. Alternatively, user roles assigned for other purposes in a chat room may be used for content tagging and limited sharing. This information may, for example, be used via public or private APIs, manual entry, or use of a tool such as a web crawler by a company to access information from its own database that is not available under a straightforward API. Alternatively, roles may be assigned by a contractor to various subcontractors based on an email address field, which may indicate the company the subcontractor works for.

In a further embodiment, roles may be assigned by a process of artificial intelligence. Artificial intelligence may include techniques such as machine learning, deep learning, and neural networks. For example, an event planning agency may use data collected by an opt-in procedure to train a neural network in determining what roles should be assigned to users.

In yet another embodiment, roles may be assigned using a combination of these methods. For example, roles may be assigned by artificial intelligence, but manually checked and modified by users. Alternatively, artificial intelligence may suggest roles for users to assign. As yet another example, roles may be initially set by HR management software and modified manually afterwards, but automatically removed when HR management software indicates that a user is no longer working for the company.

In at least one embodiment, roles may be divided by groups or categories consisting of specific roles that form under a general role. For example, a company may assign a legal role for employees in the legal department; attorney, paralegal, and compliance roles under the legal role, and patent attorney, tax attorney, and environmental attorney roles under the legal role.

In another embodiment, roles may be divided into higher and lower levels. For example, a level 1 security role and level 2 security role may both exist where the level 2 security role has access to the tags of the level 1 security role plus some additional set of tags.

In a further embodiment, roles may be used for purposes other than content tagging and limited sharing. For example, roles may be used to determine which users have the privilege to assign other roles. A CEO may have authority to assign any other role, and a CFO may have the authority to assign the finance role and any role under the finance role.

In an alternate embodiment, some roles may be limited. For example, there may only be one CEO role. If a user attempt to assign a new CEO while the role is limited to only one, the previous CEO role may be removed, or the new user's assignment may fail, leaving the old CEO role in place. Alternatively, a role may only be assignable once per year.

In at least one embodiment roles may be reassigned, modified, or removed. For example, if Alice and Bob are employees of a company, and Alice moves to a new job role and Bob quits his job, Alice's roles may be modified, and Bob's roles may be removed. Additionally, new roles may be added over time. For example, a contractor may add roles for subcontractors.

In another embodiment, identifying roles may include mapping roles to tags. The mapping may be a direct 1:1 mapping, a one-to-many mapping in either way, or a more complex mapping. Such a mapping may be determined upon identifying a role, upon identifying a new tag, upon determining the correct tag to use at 204, or at any other time. Mapping will be discussed further below at 204.

In at least one embodiment, roles may be assigned or mediated using secure technologies, such as accounts with passwords, cryptocurrency wallets, smart contracts, and secure APIs. For example, roles may be assigned to a cryptocurrency wallet and mediated by non-fungible tokens (NFTs). Moreover, some of these NFTs may be “soulbound tokens,” which cannot be reassigned to a new wallet. Soulbound tokens may be used, for example, for roles that should not be reassigned to other users.

Then, at 204, the content tagging and limited sharing program 150 determines tags corresponding to parts of a document. Tags, for example, may correspond to the subject or content of a section, the language a section is written in, confidential nature of a section, intended readers for a section, or roles associated with a section. Determining tags may be performed, for example, manually by a user, using an algorithmic process, or by a combination of these methods.

In at least one embodiment, a user may determine tags for a document. For example, a user may tag a musical score for a full film according to musical instrument involved in each song, tag tempos of songs, themes of songs, and whether or not the songs have lyrics. A user may additionally apply tags to a document, for example by typing the tags inline next to section headers.

In another embodiment, tags may be determined by an algorithmic process, including, for example, lexical analysis, use of APIs, and artificial intelligence. For example, an algorithmic process may determine that words relating to food, drinks, silverware, porcelain, a kitchen, or tablecloths should be tagged with a catering tag. Alternatively, an algorithmic process may use a more advanced technique of natural language processing to determine appropriate tags in a given context.

In a further embodiment, tags may be determined by a process of artificial intelligence. Artificial intelligence may include techniques such as machine learning, deep learning, and neural networks. A marketing firm may, for example, use data collected by opt-in procedures to train a neural network in determining what tags should be assigned to various advertising analytic data.

In yet another embodiment, tags may be determined by a process combining the techniques above. For example, a neural network may provide users in a hospital with suggestions of which tags to apply to a given section of a document, after which a user may manually select those tags or others.

In at least one embodiment, tags be arranged in a hierarchy. In an event planning context, for example, general tags may include a location tag, a facility tag, and a food tag. Location tags may include an address tag, directions tag, or a venue layout tag; facility tags may include lighting tags, power tags, or sound tags; food tags may include kitchen tags, menu tags, and drink tags.

In a preferred embodiment, a tag may indicate that associated roles should have access to a section of a document, or that certain content in a document is relevant to associated roles. For example, a section with a “food” tag may be accessible by users with a “catering” role. Alternatively, tags may indicate exclusive access. For example, a section with a “confidential 2” tag may only appear in views for users with a “security clearance 2” role, or an equivalent role of higher rank. Exclusive access tags may override or may be overridden by ordinary tags.

In at least one embodiment, determining tags may include mapping tags to roles. The mapping may be a direct 1:1 mapping, a one-to-many mapping in either way, or a more complex mapping. Such a mapping may be determined upon identifying or assigning a role, upon identifying a new tag, upon determining the correct tag to use, or at any other time. Mapping may be performed manually, by an algorithmic process, or by a combined process. In at least one embodiment, mapping may occur in the same manner as the manner in which tags or roles are determined.

In another embodiment, tagged sections may be a section in the layout of a document, logical sections of a document, pages of a document, sub-documents within an organizational document structure such as a database or directory, a selection of characters, or any other portion of a document.

Then, at 206, the content tagging and limited sharing program 150 filters a view of the document to specific tags according to a user's roles. Filtering a view may be performed by removing portions of a document for a view sent to a user, positively selecting portions of a document to be provided to a user, sending a complete document to a user with certain portions marked as hidden, sending a complete document to a user with certain portions highlighted or emphasized, or otherwise modifying a document in support of providing a user with a view limited to the appropriate views.

In at least one embodiment, filtering a view may be performed by removing portions that do not match tags that are mapped to a user's roles, or portions that are tagged by exclusive tags for roles a user does not have. For example, if a document with patient information includes medical information, billing information, and personal information, a user with a nurse role may receive a document view with billing information removed from the full document.

In another embodiment, filtering a view may be performed by positively selecting portions of a document to be provided to a user. For example, if a document with patient information includes medical information, billing information, and personal information, a user with a financial role may receive a document view with only billing information included. Positive selection may further include use of exclusive tags to remove portions for which a user should not have access. For example, a user with a financial role may receive a document view with only billing information included, and with medical information that is also billing information removed from the view if the medical information tag is an exclusive tag.

In yet another embodiment, filtering a view may be performed by sending a complete document to a user with certain portions marked as hidden. For example, if a document instructs student users about homework roles, a user responsible for a presentation may receive a view with the “general” and “presentation” sections visible, but other portions hidden. Such a view may further be secured using known security methods such as encryption, so that hidden sections are not accessible by users without the appropriate roles, or may be available to users but hidden so that relevant information is more accessible or more convenient. Alternatively, portions of a document marked as hidden may be de-emphasized, such as by changing font colors to reduce contrast, or by hiding large elements such as images or charts.

In another embodiment, filtering a view may be performed by sending a complete document to a user with certain portions highlighted or emphasized. For example, if a document instructs student users about homework roles, a user responsible for a presentation may receive a view with the “general” and “presentation” sections highlighted or emphasized in some other way, such as by having its font size increased. Emphasizing may also include providing additional contextual information, such as a “presenter” icon representing a “presenter” role in the margin of the document next to relevant section headings.

In a further embodiment, filtering may modify the layout of a document in other ways, for example to make the layout of the filtered view more coherent. As a more specific example, numbered sections may be renumbered according to only the visible sections.

In at least one embodiment, a view may be filtered in response to a request from a user, such as an HTTP request from a URL generated at 208. Alternatively, a view may be filtered in advance of a request from a user, or at any other time. For example, if a document only has two tags associated with only two roles, four views may be generated and stored for quick sharing: one view for each tag, one view for neither tag, and one view for both tags.

In a further embodiment, views may be re-filtered at any time after initial filtering. For example, views may be regenerated as a document is changed, as tags are changed, as mappings are changed, as roles are changed, or as users with new role combinations are added. Alternatively, views may be regenerated in response to a modified request. For example, a document view may contain buttons that allow a user to view according to different roles. More specifically, an event planner may have options to view a document from a role as a caterer, or from a role as a deejay, and selecting one of these roles may create a new view.

Then, at 208, the content tagging and limited sharing program 150 provides a filtered view to the appropriate user. A filtered view may be provided directly or indirectly, for example by an access uniform resource identifier (URI).

In at least one embodiment, providing a filtered view may include sending a filtered view directly to a user, for example over the hypertext transfer protocol (HTTP), over a file transfer protocol (FTP), through a messaging protocol, or through email. Alternatively, providing a filtered view directly may include handing a device with a filtered view to a user in person, printing out a filtered view and providing the printed out copy to a user, or using a screen reader to read out the content of a filtered view for a user.

In another embodiment, providing a filtered view may include indirect methods, such as providing access to a filtered view by a URI, adding access to a filtered view to a user's account, or placing a filtered view in a location in which the user has access. For example, a URI might be formatted to include a list of roles that represent a user, a username associated with a user's roles on a server, a secure authentication token representing the user, or the tags to be included in a filtered view. Alternatively, a filtered view of a document may be placed in a user's cloud folder for the user to access at will.

In yet another embodiment, providing a filtered view may include modifying a document already on a user's device to a filtered view. For example, if an event planner is looking at a complete document, the event planner may have options to view a document from a role as a caterer, or from a role as a deejay, and selecting one of these roles may filter the event planner's full document to a filtered view on the event planner's device, providing the event planner with the filtered view.

In another embodiment, providing a filtered view may be performed using known secure methods, such as encryption, message authentication, tokenization, checking a user account, or using a blockchain wallet or NFT. For example, a URI may include portions that use a message authentication code so that unauthorized users cannot simply add roles or tags to the URL to gain access. Alternatively, a URI may include roles in plaintext, but a document may only be provided to users who use the URI and are logged in to accounts with the appropriate roles. Alternatively, a view may only be accessible to users who have authenticated as owners of a blockchain wallet with one or more NFTs representing certain roles.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying one or more roles corresponding to one or more users;
determining a set of tags corresponding to sections of a document;
associating tags from the set of tags with associated roles from the one or more roles;
filtering a view of the document for a user from the one or more users according to the tags from the set of tags, the associated roles, and a set of roles corresponding to the user; and
presenting the view to the user.

2. The method of claim 1, wherein providing the view of the document to the user is performed using a message authentication code as a security measure.

3. The method of claim 1, wherein a role from the one or more roles is identified by a non-fungible token in a blockchain wallet.

4. The method of claim 3, wherein the non-fungible token is a soulbound token.

5. The method of claim 1, wherein determining the set of tags is performed using artificial intelligence and a neural network.

6. The method of claim 1, wherein associating tags with associated roles is performed using artificial intelligence and a neural network.

7. The method of claim 1, further comprising determining one or more higher-level tags that include one or more lower-level tags from the set of tags and associating higher-level tags with associated roles.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying one or more roles corresponding to one or more users;
determining a set of tags corresponding to sections of a document;
associating tags from the set of tags with associated roles from the one or more roles;
filtering a view of the document for a user from the one or more users according to the tags from the set of tags, the associated roles, and a set of roles corresponding to the user; and
presenting the view to the user.

9. The computer system of claim 8, wherein providing the view of the document to the user is performed using a message authentication code as a security measure.

10. The computer system of claim 8, wherein a role from the one or more roles is identified by a non-fungible token in a blockchain wallet.

11. The computer system of claim 10, wherein the non-fungible token is a soulbound token.

12. The computer system of claim 8, wherein determining the set of tags is performed using artificial intelligence and a neural network.

13. The computer system of claim 8, wherein associating tags with associated roles is performed using artificial intelligence and a neural network.

14. The computer system of claim 8, further comprising determining one or more higher-level tags that include one or more lower-level tags from the set of tags and associating higher-level tags with associated roles.

15. A computer program product, the computer program product comprising:
one or more computer-readable tangible storage medium and program instructions stored on at least one of the one or more tangible storage medium, the program instructions executable by a processor capable of performing a method, the method comprising:
identifying one or more roles corresponding to one or more users;
determining a set of tags corresponding to sections of a document;
associating tags from the set of tags with associated roles from the one or more roles;
filtering a view of the document for a user from the one or more users according to the tags from the set of tags, the associated roles, and a set of roles corresponding to the user; and
presenting the view to the user.

16. The computer program product of claim 15, wherein providing the view of the document to the user is performed using a message authentication code as a security measure.

17. The computer program product of claim 15, wherein a role from the one or more roles is identified by a non-fungible token in a blockchain wallet.

18. The computer program product of claim 17, wherein the non-fungible token is a soulbound token.

19. The computer program product of claim 15, wherein determining the set of tags is performed using artificial intelligence and a neural network.

20. The computer program product of claim 15, wherein associating tags with associated roles is performed using artificial intelligence and a neural network.
